(19) United States
(12) Patent Application Publication
(10) Pub. No.: US 2009/0009628 A1
(43) Pub. Date: Jan. 8, 2009

(54) CAPTURING AN IMAGE WITH A CAMERA INTEGRATED IN AN ELECTRONIC DISPLAY

(76) Inventor: Michael Janicek, San Jose, CA (US)

Correspondence Address: PVF -- APPLE INC.;c/o PARK, VAUGHAN & FLEMING LLP, 2820 FIFTH STREET, DAVIS, CA, 95618-7759, US

(21) Appl. No.: 11/774,074

(22) Filed: Jul. 6, 2007

(51) Int. Cl. H04N 5/76; H04N 5/222

(52) U.S. Cl. 348/231.99; 348/333.01; 348/E05.031

(57) ABSTRACT

Embodiments of the present invention provide a system for capturing photographic images with a camera integrated in an electronic display. The system includes: a display screen; a set of display elements coupled to a front side of the display screen; and an image-capturing mechanism coupled to a backside of the display screen. The display elements are configured to cycle between an active state, in which the display elements are illuminated to display a display image on the display screen, and an inactive state, in which the display elements are darkened and at least partially transparent. While the display elements are in the inactive state, the image-capturing mechanism is configured to capture a photographic image of objects in front of the display screen through the display screen and the display elements.

### BACKGROUND

1. Field of the Invention

Embodiments of the present invention relate to techniques for capturing images. More specifically, embodiments of the present invention relate to a technique for capturing an image with a camera integrated in an electronic display.

2. Related Art

Many personal computers, cell phones, personal digital assistants, and other electronic devices include built-in video cameras. These cameras enable users to take pictures, capture video, and participate in videoconferences.

One problem with traditional built-in cameras stems from the way that the cameras are mounted to (or within) the electronic device. Because the cameras are attached to a mounting point that is adjacent to the user's video display, the user cannot simultaneously look into the camera and view his or her display. Hence, it is difficult for the user to maintain eye contact during a videoconference with another person, because looking at the other person in the display means looking away from the camera. Users find themselves constantly looking back and forth between the display screen and the camera, which can be distracting and make the conversation seem awkward and unnatural. For the same reason, when attempting to take a self-portrait, a user cannot see what the photo will actually look like because glancing at the display means looking away from the camera. When looking at their display, users see an image of themselves looking away at an angle instead of looking directly into the camera. Thus, users that want a head-on portrait must look away from the display and into the camera, shooting blindly without any visual feedback from the display to guide them.

Hence, what is needed is a camera in a computer system that does not suffer from the above-described problems.

### SUMMARY

Embodiments of the present invention provide a system for capturing photographic images with a camera integrated in an electronic display. The system includes: a display screen; a set of display elements coupled to a front side of the display screen; and an image-capturing mechanism coupled to a backside of the display screen. The display elements are configured to cycle between an active state, in which the display elements are illuminated to display a display image on the display screen, and an inactive state, in which the display elements are darkened and at least partially transparent. While the display elements are in the inactive state, the image-capturing mechanism is configured to capture a photographic image of objects in front of the display screen through the display screen and the display elements.

In some embodiments, the image-capturing mechanism includes two or more separate image-capturing mechanisms coupled to the backside of the display screen at different locations. The separate image-capturing mechanisms are configured to capture photographic images of objects in front of corresponding portions of the display screen through the display screen and the display elements while the display elements are in the inactive state. In some embodiments, the system includes an image-generation mechanism that is configured to generate a composite photographic image from the photographic images captured by the separate image-capturing mechanisms.

In some embodiments, the image-capturing mechanism includes a light-focusing mechanism which focuses received light onto a CMOS photosensitive array, an array of photodiodes, and/or an electronic image sensor.

In some embodiments, the display elements are configured to cycle between the active state and the inactive state repeatedly.

In some embodiments, the image-capturing mechanism is configured to capture a photographic image during more than one consecutive inactive state and to combine the photographic images to generate a composite photographic image or a movie.

In some embodiments, the display elements are configured to substantially minimize the period of time in the inactive state to reduce the appearance of flicker of the display screen.

In some embodiments, the display elements are organic light-emitting diodes (OLEDs).

In some embodiments, the display screen is coupled to a laptop computer, a desktop computer, a cellular phone, a personal digital assistant (PDA), an electronic organizer, a media player, an advertisement-generation mechanism, a security mechanism, an automated teller machine (ATM), an instrument panel or console, or another electronic device.

In some embodiments, the photographic image is a still image, a frame of video, or another type of image representation.

### BRIEF DESCRIPTION OF THE FIGURES

FIG. 1 presents a block diagram illustrating an electronic device in accordance with embodiments of the present invention.

FIG. 2A presents a laptop computer where a set of display elements are in an active state in accordance with embodiments of the present invention.

FIG. 2B presents a laptop computer where a set of display elements are in an inactive state in accordance with embodiments of the present invention.

FIG. 2C presents an image-capturing mechanism coupled to display screen in accordance with embodiments of the present invention.

FIG. 3 presents a flowchart illustrating the process of capturing an image in accordance with embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Electronic Device

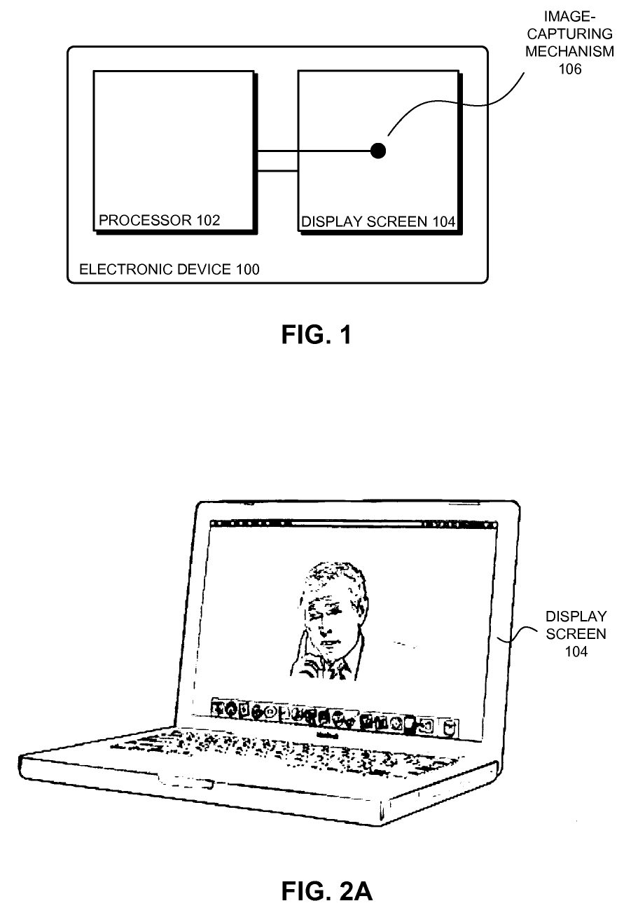

FIG. 1 presents a block diagram illustrating an electronic device 100 in accordance with embodiments of the present invention. Electronic device 100 includes processor 102, display screen 104, and image-capturing mechanism 106. In some embodiments of the present invention, electronic device 100 is a general-purpose electronic device that is used to capture still images and/or video. For example, electronic device could be used for video-conferencing and/or taking pictures.

Processor 102 is a central processing unit (CPU) that processes instructions. For example, processor 102 can be a microprocessor, a controller, an ASIC, or another type of computational engine. Display screen 104 is an electronic display screen that provides a user with a visual interface to electronic device 100. For example, display screen 104 can be a monitor, a display on a cell phone, a display on a PDA, a display on a camera, or another form of visual interface.

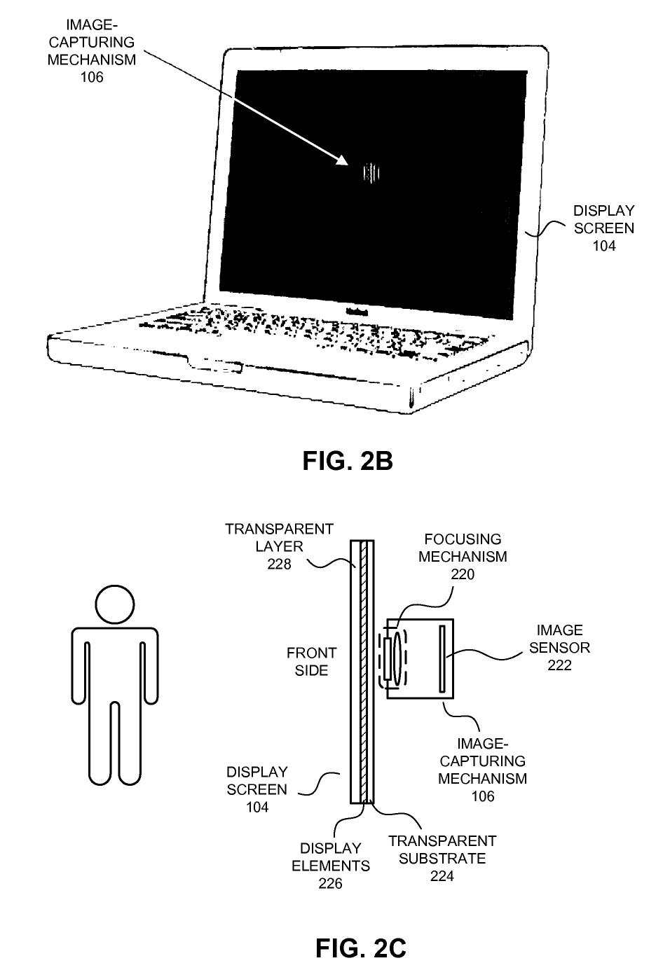

Display screen 104 is comprised of a number of display elements 226 (e.g., pixels) (see FIG. 2C) that cycle between an active state, wherein the display elements 226 light up to display the image on display screen 104, and an inactive state, wherein the display elements 226 are darkened and at least partially transparent. For example, FIG. 2A presents a laptop computer where the display elements 226 are in the active state in accordance with embodiments of the present invention. In contrast, FIG. 2B presents a laptop computer where the display elements 226 are in the inactive state in accordance with embodiments of the present invention.

In some embodiments of the present invention, the display elements 226 on display screen 104 are organic light-emitting diodes (OLEDs). An OLED belongs to a family of light-emitting diodes (LEDs) whose emissive electroluminescent layer is manufactured from organic compounds. An OLED typically includes a polymer substance that allows electroluminescent organic compounds to be deposited in rows and columns to form a matrix of pixels on a flat carrier. The resulting matrix of pixels can emit light of different colors. OLEDs are particularly suitable for display elements for electronic device 100, because OLEDs are capable of very high refresh rates (e.g., 1000 times faster than liquid crystal displays (LCDs)). Furthermore, OLEDs, when in the inactive state, can be 85% or more transparent.

Note that although we describe embodiments that use OLEDs as display elements 226, alternative embodiments use other types display elements that provide high refresh rates and at least partial transparency.

Image-capturing mechanism 106 is a device that is used to capture photographic images. Image-capturing mechanism 106 includes one or more lenses, mirrors, prisms, filters, diffractors, shutters, apertures, and/or other elements that focus light and a photosensitive detector that converts light into electrical signals. For example, image-capturing mechanism 106 can include an aperture and a lens that focus light onto an electronic image sensor, a CMOS photosensitive array, and/or one or more photodiodes.

During operation, the light-focusing mechanism focuses received light onto the photosensitive detector. The photosensitive detector converts the received light into an electrical signal that is forwarded to processor 102. Processor 102 uses the electrical signal to create a digital image.

In some embodiments of the present invention, image-capturing mechanism 106 is coupled to display screen 104 behind the display elements 226. For example, image-capturing mechanism 106 can be coupled to the backside of the center of display screen 104, behind the display elements 226 located in that area (as seen in FIG. 2B).

In some embodiments of the present invention, image-capturing mechanism 106 includes two or more separate image-capturing mechanisms which are coupled to display screen 104 in different locations. For example, the separate image-capturing mechanisms can be coupled to each of the corners of the backside of display screen 104 behind the display elements 226. For these embodiments, electronic device 100 generates a single image using the separate images captured by the parts of image-capturing mechanism 106. In this embodiments, software or hardware within electronic device 100 can stitch the separate images into a single image.

In some embodiments, image-capturing mechanism 106 captures a separate photographic image during two or more consecutive inactive states (i.e., as the display elements 226 cycle from the active state to the inactive state two or more times) and combines the separate photographic images to generate a composite photographic image or a movie. For example, display screen 104 may cycle from the inactive state to the active state 3 times in 50 ms as display screen 104 refreshes. In each inactive state, image-capturing mechanism 106 captures a separate image. Processor 102 can then generate a composite image from the three separate images.

In some embodiments of the present invention, the cycle between the active state and the inactive state is set to be short enough to minimize the appearance of display “flickering.” For example, assuming that the frame rate is the rate at which some or all of the lines in display screen 104 are updated to provide consecutive images to the user, electronic device may have frame rates of 60 or more frames per second.

In some embodiments of the present invention, electronic device 100 can be part of a security or information system, such as can be found in an airport, an automated teller machine (ATM), or a casino. For example, display screen 104 may display flight information, transaction information, or an online game, but may also serve as an image-capturing mechanism that facilitates facial recognition or monitoring to deter or prevent criminal activity. Alternatively, electronic device can be an advertising-display mechanism. For example, advertising signs may be configured to display advertisements of a particular type to different passers-by based on a computational estimation of the interests of the passers-by.

Image-Capturing Mechanism

FIG. 2C presents an image-capturing mechanism 106 coupled to display screen 104 in accordance with embodiments of the present invention. (Note that the Elements in FIG. 2c are not to Scale.)

Image-capturing mechanism 106 includes focusing mechanism 220 and image sensor 222. Focusing mechanism 220 focuses light onto image sensor 222 which converts the focused light into an electrical signal that can be used to generate an image or video. Focusing mechanism 220 can include lenses, mirrors, prisms, filters, diffractors, shutters, apertures, and/or other elements that control the amount of light incident onto image sensor 222. Image sensor 222 can include a photosensitive CMOS array, an electronic image sensor, an array of photodiodes, and/or another mechanism that converts the focused light into an electrical signal.

Display screen 104 includes display elements 226, which are coupled between transparent layer 228 and transparent substrate 224. Transparent layer 228 and transparent substrate 224 provide a protective layer for display elements 226, as well as providing mechanical stability for display screen 104. Although we describe embodiments that use transparent layer 228 and transparent substrate 224, alternative embodiments use other configurations of display elements 226 and layers/substrates.

Display elements 226 cycle between an active state, wherein the display elements 226 light up to display an image on display screen 104, and an inactive state, wherein display elements 226 are darkened and at least partially transparent. When display elements 226 are in the inactive state (and are therefore at least partially transparent), image-capturing mechanism 106 can capture an image through display screen 104 (i.e., through transparent layer 228, display elements 226, and transparent substrate 224).

In some embodiments, image-capturing mechanism 106 includes a controller that controls the positions and/or orientations of lenses, mirrors, prisms, filters, diffractors, shutters, apertures, and/or other elements to focus or to compensate for various lighting and/or environmental conditions. For example, image-capturing mechanism 106 can increase a shutter speed in bright conditions. Alternatively, image-capturing mechanism 106 can move one or more lenses relative to one another to zoom in on a given object.

In some embodiments, software or additional hardware is used to manipulate the image generated from the electrical signal (or the electrical signal itself) from image sensor 222. For example, in some embodiments, digital (software) zoom facilitates focusing on one area of a captured image. Alternatively, an external hardware or software digital signal processor can provide visual noise reduction or electronic zoom, remove artifacts from the image, or can provide other forms of correction for the image.

Although we depict a space (i.e., an air gap) between display screen 104 and image-capturing mechanism 106, in alternative embodiments, image-capturing mechanism 106 is coupled directly to the backside of display screen 104.

### Image-Capturing Process

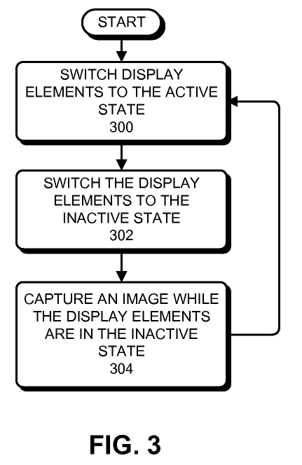

FIG. 3 presents a flowchart illustrating the process of capturing an image in accordance with embodiments of the present invention. The process starts when electronic device 100 switches a set of display elements 226 in display screen 104 to the active state (step 300). For example, when electronic device is first turned on, electronic device 100 can switch the display elements 226 to the active state to display a still image or a video on display screen 104.

Electronic device 100 then switches the display elements 226 to the inactive state (step 302). In some embodiments of the present invention, the display elements 226 can be switched to the inactive state specifically to capture an image. In other embodiments, the display elements 226 can be switched to the inactive state in order to refresh the image (i.e., to display the next consecutive image or portion of an image on display screen 104). In each of these embodiments, an image can be captured by image-capturing mechanism 106 while the display is in the inactive state.

Next, electronic device 100 captures an image while the display elements 226 are in the inactive state (step 304). In embodiments of the present invention, the display elements 226 are at least partially transparent in the inactive state, which allows image-capturing mechanism 106 to capture the image through the display elements 226 (and the display screen 104). Electronic device 100 then returns to step 300 to switch the display elements 226 to the active state.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus for capturing photographic images, comprising:
a display screen;
a set of display elements coupled to a front side of the display screen, wherein the display elements are configured to cycle between an active state, in which the display elements are illuminated to display a display image on the display screen, and an inactive state, in which the display elements are darkened and at least partially transparent; and
an image-capturing mechanism coupled to a backside of the display screen;
wherein while the display elements are in the inactive state, the image-capturing mechanism is configured to capture a photographic image of objects in front of the display screen through the display screen and the display elements.

2. The apparatus of claim 1, further comprising:
an image-generation mechanism;
wherein the image-capturing mechanism includes two or more separate image-capturing mechanisms coupled to the backside of the display screen at different locations;
wherein while the display elements are in the inactive state, the separate image-capturing mechanisms are configured to capture photographic images of objects in front of corresponding portions of the display screen through the display screen and the display elements; and
wherein the image-generation mechanism is configured to generate a composite photographic image from the photographic images captured by the separate image-capturing mechanisms.

3. The apparatus of claim 1, wherein the image-capturing mechanism includes a light-focusing mechanism which focuses received light onto a CMOS photosensitive array, an array of photodiodes, and/or an electronic image sensor.

4. The apparatus of claim 3, wherein the display elements are configured to cycle between the active state and the inactive state repeatedly.

5. The apparatus of claim 4, wherein the image-capturing mechanism is configured to capture a photographic image during more than one consecutive inactive states and to combine the photographic images to generate a composite photographic image or a movie.

6. The apparatus of claim 4, wherein the display elements are configured to substantially minimize the period of time in the inactive state to reduce the appearance of flicker of the display screen.

7. The apparatus of claim 1, wherein the display elements are organic light-emitting diodes (OLEDs).

8. The apparatus of claim 1, wherein the display screen is coupled to a laptop computer, a desktop computer, a cellular phone, a personal digital assistant (PDA), an electronic organizer, a media player, an advertisement-generation mechanism, a security mechanism, an automated teller machine (ATM), an instrument console or control panel, or another electronic device.

9. The apparatus of claim 1, wherein the photographic image is a still image, a frame of video, or another type of image representation.

10. A computing device for capturing photographic images, comprising:
a processor;
a memory coupled to the processor, wherein the memory stores data and instructions for the processor;
a display screen coupled to the processor;
a set of display elements coupled to a front side of the display screen and to the processor, wherein the processor is configured to cycle the display elements between an active state, wherein the display elements light up to display the image on the display screen, and an inactive state, wherein the display elements are darkened and at least partially transparent; and
an image-capturing mechanism coupled to a backside of the display screen and to the processor;
wherein while the display elements are in the inactive state, the processor is configured to use the image-capturing mechanism to capture a photographic image of objects in front of the display screen through the display screen and the display elements.

11. The computing device of claim 10, further comprising:
an image-generation mechanism;
wherein the image-capturing mechanism includes two or more separate image-capturing mechanisms coupled to the backside of the display screen at different locations;
wherein while the display elements are in the inactive state, the processor is configured to use each of the separate image-capturing mechanisms to capture a photographic image of objects in front of a corresponding portion of the display screen through the display screen and the display elements; and
wherein the processor is configured to use the image-generation mechanism to generate a composite photographic image from the photographic images captured by the separate image-capturing mechanisms.

12. The computing device of claim 10, wherein the image-capturing mechanism includes a light-focusing mechanism which focuses received light onto a CMOS photosensitive array, an array of photodiodes, and/or an electronic image sensor.

13. The computing device of claim 12, wherein the display elements are configured to cycle between the active state and the inactive state repeatedly.

14. The computing device of claim 13, wherein the image-capturing mechanism is configured to capture a photographic image during more than one consecutive inactive states and to combine the photographic images to generate a composite photographic image or a movie.

15. The computing device of claim 13, wherein the display elements are configured to substantially minimize the period of time in the inactive state to reduce the appearance of flicker of the display screen.

16. The computing device of claim 10, wherein the display elements are organic light-emitting diodes (OLEDs).

17. The computing device of claim 10, wherein the photographic image is a still image, a frame of video, or another type of image representation.

18. A method for capturing photographic images, comprising:
switching a set of display elements coupled to a front side of a display screen from an active state, wherein the display elements light up to display an image on the display screen, to an inactive state, wherein the display elements are darkened and at least partially transparent; and
capturing a photographic image using an image-capturing mechanism coupled to the backside of the display screen, wherein capturing the image involves capturing a photographic image of objects in front of the display screen through the display screen and the display elements.

19. The method of claim 18, wherein the image-capturing mechanism is comprised of two or more separate image-capturing mechanisms coupled to the backside of the display screen at different locations, wherein the method further comprises:
while the display elements are in the inactive state, using the two or more separate image-capturing mechanisms to capture a photographic image of objects in front of corresponding portions of the display screen through the display screen and the display elements; and
generating a composite photographic image from the photographic images captured by the separate image-capturing mechanisms.

20. The method of claim 18, wherein capturing the photographic image of objects in front of the display screen involves focusing received light through a focusing mechanism on to a CMOS photosensitive array, an array of photodiodes, and/or an electronic image sensor.

21. The method of claim 20, wherein the method further comprises cycling the display elements between the active state and the inactive state repeatedly.

22. The method of claim 21, wherein the method further comprises using the image-capturing mechanism to capture a photographic image during more than one consecutive inactive states and combining the photographic images to generate a composite photographic image or a movie.

23. The method of claim 21, wherein the method further comprises minimizing the period of time that the display elements are in the inactive state to reduce the appearance of flicker of the display screen.

24. The method of claim 18, wherein the display elements are organic light-emitting diodes (OLEDs).

25. The method of claim 18, wherein the photographic image is a still image, a frame of video, or another type of image representation.
